(19) United States
(12) Patent Application Publication
(10) Pub. No.: US 2013/0046773 A1
(43) Pub. Date: Feb. 21, 2013

(54) METHOD AND APPARATUS FOR USER-BASED TAGGING OF MEDIA CONTENT

(71) Applicants: Navneeth N. Kannan, Doylestown, PA (US); Vinay V. Rao, Los Gatos, CA (US); Naveen K. Singh, Santa Clara, CA (US); Bhikshavarti Mutt Vinay Raj, Mountain View, CA (US)

(72) Inventors: Navneeth N. Kannan, Doylestown, PA (US); Vinay V. Rao, Los Gatos, CA (US); Naveen K. Singh, Santa Clara, CA (US); Bhikshavarti Mutt Vinay Raj, Mountain View, CA (US)

(73) Assignee: GENERAL INSTRUMENT CORPORATION, Horsham, PA (US)

(21) Appl. No.: 13/212,214

(22) Filed: Aug. 18, 2011

(51) Int. Cl. G06F 17/30

(52) U.S. Cl. 707/754; 707/E17.059

(57) ABSTRACT

A system (100) and method (400) for creating collaborative tags is provided. During the presentation of content, a tagging device (101) receives user input (305) corresponding to the content. The tagging device (101) associates the user input (305) with metadata (306) identifying the content. The content itself is not attached to the tag (300). A distribution filter (307) can be attached to the tag (300), as can a content level classification (308). The tag (300) is then transmitted to a server (107) for distribution in accordance with the distribution filter (307). A subsequent user can request the tags for presentation with later content.

### BACKGROUND

1. Technical Field

This invention relates generally to media devices, and more particularly to interactive media devices.

2. Background Art

The presentation of multimedia content, such as television programs, movies, and videos, has changed dramatically in the last few decades. Not too long ago, watching television was a real time activity with limited viewer interaction. To watch a program, a person had to be present in front of the television at the very time the show was broadcast. The person's control over the television was limited to turning it on and off and changing the channel.

The advent of videocassette recorders (VCRs) changed the consumption of multimedia content from a real time activity to a “time of your choosing” activity by introducing the concept of time shifting. Rather than having to be present when a program aired, a user could program a recorder to capture the program on recordable media, thereby allowing the user to watch the program at the time of their choosing. Digital video recorders (DVRs) also allow a user to record multimedia content. However, DVRs offer users additional levels of control due to the fact that content is recorded digitally, rather than on serial media. This allows a user to simply and quickly pause, rewind, fast forward, and jump to specific content without having to wait for a tape or other media to spool. In short, while original televisions only allowed a user to watch what was shown, VCRs and DVRs allowed users to watch what they wanted when they wanted, with DVRs making the process more efficient.

The advent of multi-room DVRs and other devices have extended the user experience further. With a multi-room DVR, a user can use a single device to record multimedia content. The same device can playback the content in any room in the house. Further, content distribution devices can be coupled to modern DVRs to transmit content across the Internet to deliver recorded content to a user's computer, tablet, or mobile phone. Such devices allow a user to watch what they want, when they want, where they want.

Despite these advances, current technology still suffers from limitations. While the ability to control what content is consumed is considerable, there is still little or no user interaction associated with multimedia presentation. It would be advantageous to have a system that offered increased user interaction to further enhance the multimedia content consumption experience.

### BRIEF DESCRIPTION OF THE DRAWINGS

FIG. 1 illustrates one system for collaborative multimedia content tagging suitable for use with methods described herein and configured in accordance with one or more embodiments of the invention.

FIG. 2 illustrates one server suitable for use in a system, and in accordance with methods, for collaborative multimedia content tagging configured in accordance with one or more embodiments of the invention.

FIG. 3 illustrates one tagging device suitable for use in a system, and in accordance with methods, for collaborative multimedia content tagging configured in accordance with one or more embodiments of the invention.

FIG. 4 illustrates one method for tagging media configured in accordance with one or more embodiments of the invention.

FIG. 5 illustrates one method for presenting tags configured in accordance with one or more embodiments of the invention.

FIG. 6 illustrates one method for handling tags across a network in accordance with one or more embodiments of the invention.

FIG. 7 illustrates one classification of a tag configured in accordance with one or more embodiments of the invention.

FIG. 8 illustrates other classifications of tags configured in accordance with one or more embodiments of the invention.

FIG. 9 illustrates another classification of a tag configured in accordance with one or more embodiments of the invention.

FIG. 10 illustrates a tag list configured as a highlight presentation in accordance with one or more embodiments of the invention.

FIG. 11 illustrates one explanatory use case for systems and methods of collaborative media tagging configured in accordance with one or more embodiments of the invention.

FIG. 12 illustrates another explanatory use case for systems and methods of collaborative media tagging configured in accordance with one or more embodiments of the invention.

FIG. 13 illustrates another explanatory use case for systems and methods of collaborative media tagging configured in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to media tagging and collaborative media tagging for multimedia content such as movies, television programs, videos and so forth. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of media tagging as described herein. The non- processor circuits may include, but are not limited to, a radio receiver, a radio transmitter, signal drivers, clock circuits, power source circuits, and user input devices. As such, these functions may be interpreted as steps of a method to perform media tag creation, media tag presentation, or media tag processing, storage, and handling. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide systems and methods for collaborative media tagging that provide users with an extra dimension of control and interaction when consuming multimedia content. While prior art systems provided users the ability to watch what they want, when they want, where they want, embodiments of the present invention offer additional user experience layers by providing methods and systems to allow users to watch what they want, when they want, where they want, how they want, and with whom they want. By using the collaborative media tagging systems and methods described below, users can share personal comments of multimedia content with other users. In one or more embodiments, the user creating the “tag” can elect to share it only with selected people, with a predefined social media group, or publicly. The tags can be comments on the content, such as a particular frame or scene. The tags can be ratings of the content. The tags can be on the program level, commenting on the program as a whole. Of course, combinations of these can be used as well. As a simple example, a user may create a program level tag that says, “This program is terrible,” while at the same time using a scene level tag that says, “This action scene is fantastic.”

In one or more embodiments, storage, handling, transport, and distribution of the tags is simplified and made more efficient because the tags themselves are not tied to a specific media content selection. Prior art tagging solutions attached tags to specific media. Consequently, a user wishing to see another's tags had to watch the same piece of media that was tagged. Embodiments of the present invention create tags that are not tied to content—instead they incorporate metadata from the content being presented when the tag was created that identifies the content. Accordingly, another user can watch the same program, but from a different source, and see the comments that a friend in the user's social group made. Illustrating by example, user A may watch episode A42354 of the television program “Andy Griffith” in Arizona that was recorded on a DVR after being broadcast from a station in Colorado. While watching, the user may make several tags commenting on beloved comedy gags involving Barney Fife. User B, who may be a friend of user A in a social network, may be traveling in Europe and may come across a Spanish-language dubbed episode A42354 of the program being broadcast in real time from Barcelona. Methods and systems correlate the tags with content based upon the metadata, and thus allow user B to see user A's comments even though the content comes from different sources. Advantageously, this capability eliminates the need to watch the same content that is required in prior art systems.

The decoupling of tags from content offers other advantages over prior art systems as well. For example, since the tags are “detached” from the content, tags can be sent independent of content. Continuing the example from the preceding paragraph, presume user A is an Andy Griffith aficionado. User C, who is a friend in a social media network of user A, wants to watch an episode of Andy Griffith to find out what all the fuss is about. However, User C wants to make sure he sees one of the better episodes where Barney mentions that he can only carry one bullet, and has to carry it in his pocket. User A's tags can be made available to user C on a computer, laptop computer, tablet, or mobile communication device via the social media network. User C can then scan or search the tags looking for a comment from user A such as “I always crack up when Barney talks about his bullet.” In one or more embodiments, user C can then access a hyperlink based on the metadata to view potential sources of that episode for delivery to his computer, laptop, television, tablet, mobile communication device, or other device. Other examples will be set forth in the explanatory use cases discussed below. Still others will be obvious to those of ordinary skill in the art having the benefit of this disclosure. The methods and systems described herein provide an infrastructure and system for all types of applications employing tags configured in accordance with the embodiments described herein.

As used herein, the tags or collaborative media tags represent bookmarks represent non- hierarchical categorizations of multimedia content or of a media stream. The tags can be configured as information about the multimedia content. The tags can represent bookmarks of the media stream, and can be created by users to mark any particular event, location, person, or object that they would like share with their friends. In one or more embodiments, a short comment can be associated with a tag. In some embodiments, tags can be time referenced and correlated with other content such that a shared collaborative tag will appear at the same scene or media time as that when the collaborative tag was originally created. In one or more embodiments, the tags can include information relating to the content, such as hyperlinks or other devices. Some tags can be configured as content manipulation tags that have start content or stop content functions. These content manipulation tags can be aggregated to alter the way subsequent content is presented, an example of which is a highlight presentation. In one or more embodiments, the tags are transmitted to, and stored on, a server such that they can be shared among sets or subsets of predefined social groups.

In one or more embodiments, the tags can be “classified” by assigning a content level classification to the tag. Examples of content level classifications include a scene that is created to mark a scene of interest in content, a frame tag that is created to mark a frame of interest in content, a rating tag that is created to rate an entire work of multimedia content, a recommendation tag that is created to recommend a particular piece of content to friends in a social group, a content awareness tag that is generated implicitly as a result of user interaction with a tagging device, e g , tuning to a particular content offering, scheduling a recording, purchasing a content offering, and so forth, or a content hyperlink tag that is generated to prompt users to click on a link to buy content offerings. Other classifications will be readily apparent to those of ordinary skill in the art having the benefit of this disclosure.

Sharing filters or “distribution filters” can be applied to the tags in one or more embodiments. For instance, a tag creator can assign visibility rules to his tags by assigning a distribution filter that defines to whom the tag can be made available. Examples of distribution filters include a private distribution filter that permits tags only to be visible to the tag's creator, a social group distribution filter that permits the tags for sharing with identified friends, predefined social communities, subsets of predefined social communities, and so forth, or a public distribution filter that allows a tag to be viewed by the public at large or an entire predefined community

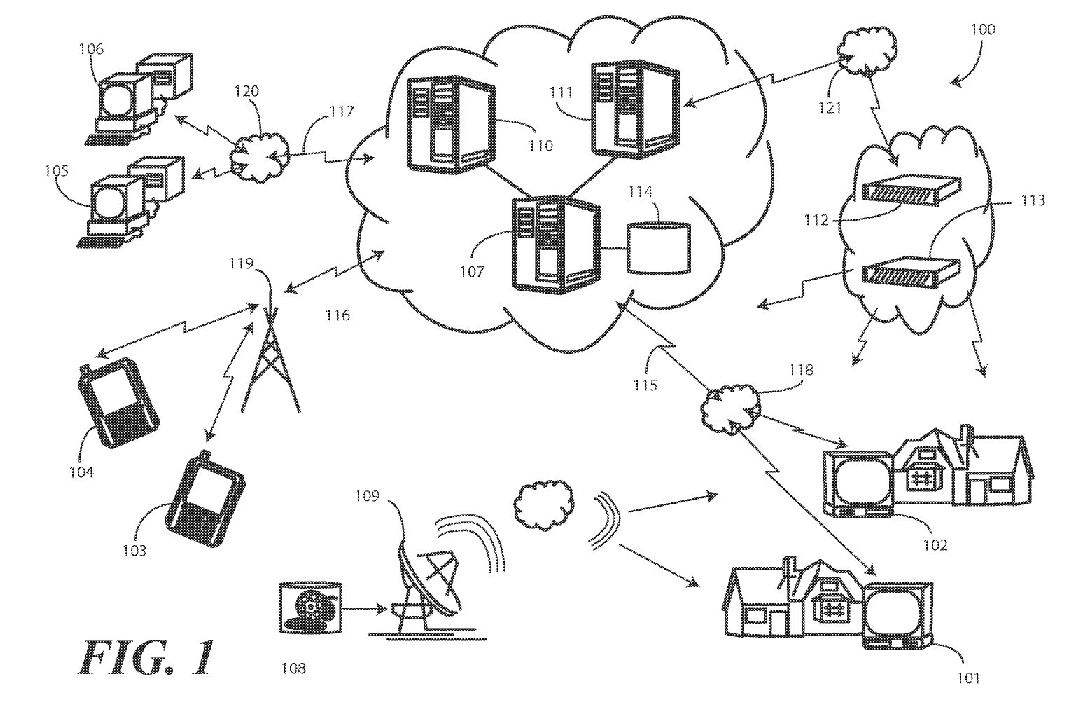

Turning now to FIG. 1, illustrated therein is one explanatory collaborative media tagging system 100 configured in accordance with one or more embodiments of the invention. The collaborative media tagging system 100 includes one or more media tagging devices 101,102,103,104,105,106 that interact across networks with a collaborative media tagging server 107. In one embodiment, the media tagging devices 101,102,103,104,105,106 communicate with the server 107 via Internet protocol communication in accordance with a collaborative media tagging protocol that will be described below. Examples of media tagging devices 101,102,103,104,105,106 shown in this illustrative embodiment include computers, mobile communication devices such as mobile telephones, and set top boxes. Media tagging devices 101,102 are configured as set top boxes, while media tagging devices 105,106 are configured as computer devices and could be any of desktop computers, portable computers, laptop or palmtop computers, or tablet computers. Mobile tagging devices 103,104 are shown illustratively as mobile “smart” phones. Other devices can be configured as tagging devices as well, as will be readily apparent to those of ordinary skill in the art having the benefit of this disclosure.

In one or more embodiments, content can come from a plurality of sources. For simplicity of discussion, content 108 is shown as being delivered from a content provider's head end 109. The content 108 can accordingly be watched in real time or recorded with the assistance of a media tagging device. For example, media tagging device 101 can be configured as a DVR so that a viewer need not be available when the content 108 is delivered from the head end 109. In one or more embodiments, the head end 109 also provides communication connectivity to one or more of the tagging devices 101,102.

The server 107 is responsible for storing tags and tagging data associated with users of the system 100. In one embodiment, server 107 stores metadata and other information corresponding to received tags in a database 114 that is operable with the server 107. In one or more embodiments, the server can be configured to filter the tags or tagging information based upon distribution, inbound, or outbound filters, user identifiers, content identifiers, predefined social groups, and so forth. The server 107, in one embodiment, is in communication with an EAM server 110 that is responsible for providing asset identification and other information corresponding to multimedia content. The server 107 can interact with the EAM server 110 to retrieve asset information as necessary.

A social media server 111 aggregates content from or with social information websites 112,113 or providers of social media network applications. Examples of social information websites 112,113 include flickr, facebook, last.fm, twitter, and MySpace. An example of the social media server 111 is described in commonly assigned US Patent Application Pub. No. 2011/0060793, entitled “Mobile Device and Method of Operating Same to Interface Content Provider Website,” Wheeler et al., inventors, which is incorporated herein by reference. Server 107 interacts with the social media server 111 to exchange friend information. For example, for users delivering tags to server 107, server 107 may interact with the social media server 111 to retrieve a predefined social community associated with each user. Server 107 can then make tags available to the predefined social community when a distribution filter attached to the tag includes a direction for distribution to the predefined social community

The server 107 interacts with the media tagging devices 101,102,103,104,105,106 across networks 118,119,120 via communication links 115,116,117. Depending upon the embodiment, the communication links 115,116,117 can be part of a single network or multiple networks, and each link can include one or more wired and/or wireless communication pathways, for example, landline (e.g., fiber optic, copper) wiring, microwave communication, radio channel, wireless path, intranet, internet, and/or World Wide Web communication pathways (which themselves can employ numerous intermediary hardware and/or software devices including, for example, numerous routers, etc.). In addition, a variety of communication protocols and methodologies can be used to conduct the communications via the communication links 115,116,117 between the tagging devices 101,102,103,104,105,106, EAM server 110, social media server 111, and external websites, e.g., social information websites 112,113, including for example, transmission control protocol/internet protocol (TCP/IP), extensible messaging and presence protocol (XMPP), file transfer protocol (FTP), and so forth. In one embodiment, the communication links, e.g., communication links 117,121, are web based. In other embodiments, the links/network and server can assume various non-web-based forms. Some networks, e.g., network 119, can be cellular or other wide area terrestrial networks. In one or more embodiments, server 107 functions as an intermediary between some tagging devices, e.g., tagging device 101, other tagging devices, e.g., tagging device 102, and other sources of information, e.g., social information websites 112,113.

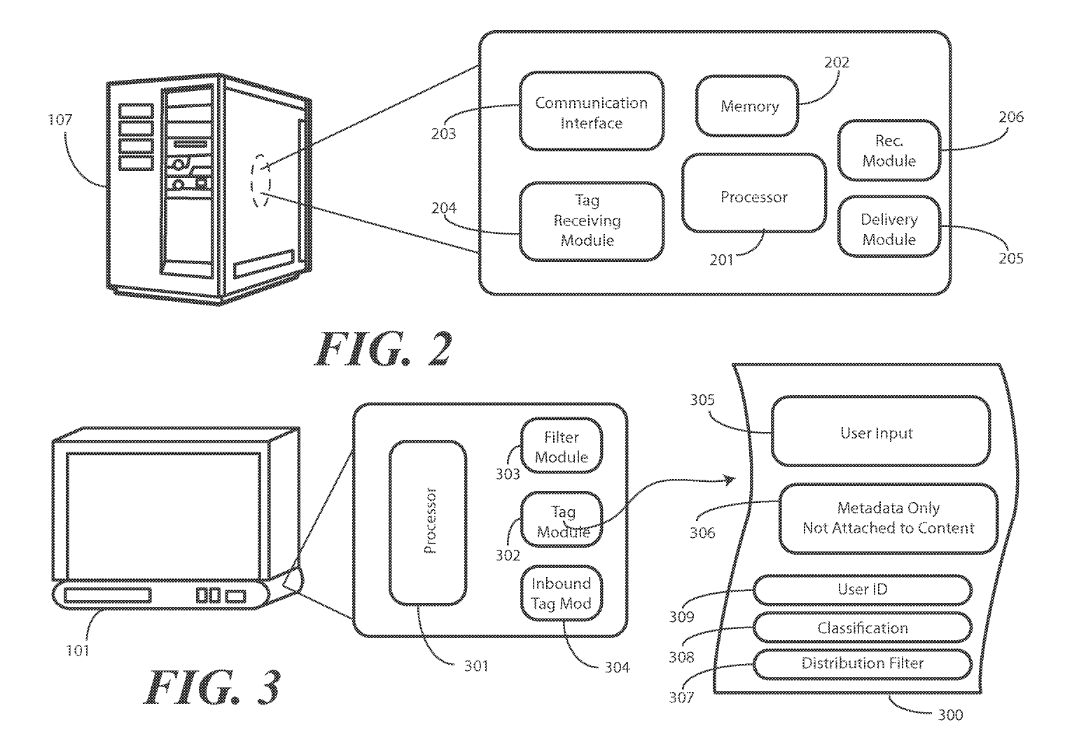

Turning to FIG. 2, illustrated therein is a functional block diagram illustrating internal components of server 107 where configured in accordance with one explanatory environment. A processor 201 is operable with a corresponding memory module 202 to execute the functions and operations of the server 107. One or more communication interfaces are configured for input/output operations and communication with the tagging devices (101,102,103,104,105,106) and are operable with the processor 201.

A tag receiving module 204 is configured for receiving tags from the tagging devices (101,102,103,104,105,106). Once received, the tags can be stored in a corresponding database (114), which is one embodiment of a memory module, or in the memory module 202. The database (114), memory module 202, or other memory devices can be one or more memory devices of any of a variety of forms, e.g., read-only memory, random access memory, static random access memory, dynamic random access memory, etc., and can be used by the processor 201 to store and retrieve data.

A tag delivery module 205 is configured to deliver tags to tagging devices (101,102,103,104,105,106) provided the proper conditions are met. In one embodiment for example, the tag comprises user input and metadata identifying media content corresponding to the user input. However, as discussed above, the tag does not have the media content attached thereto. Where the tag is configured for presentation during other offerings of the content identified in the metadata, the tag delivery module 205 can be configured to deliver the tag to one or more tagging devices upon receipt of the content or storage of the content. Note that the source of the content does not matter, as the tag delivery module 205 transmits the tag independent of the content.

An optional recommendation module 206 can be configured to mine one or more received content detached tags in response to receiving tag requests from one or more of the tagging devices (101,102,103,104,105,106. The recommendation module 206 can then deliver, through the tag delivery module 205, aggregate user data drawn from the mined tags. For example, in one embodiment the recommendation module 206 can mine user rating tags and upload the mined information to tagging devices subscribing to reviewed content. Where shared among predefined social groups, this can result in “content awareness sharing” where reviews are distributed to members of the group.

The processor 201 of the server 107 can be configured to, upon receiving tag requests from one or more of the tagging devices (101,102,103,104,105,106), deliver, through the tag delivery module 205, tags having metadata corresponding to the tag request. For instance, if a tag's metadata identifies episode 456829 of the “Beverly Hillbillies,” and one of the tagging devices is presently recording the same, the tagging device can communicate with server 107 to request tags stored at the server 107 with metadata identifying this episode.

In one or more embodiments, the processor 201 is configured to limit distribution of tags in accordance with a distribution filter. As noted above, sharing or distribution filters can be applied to the tags in one or more embodiments. A tag creator can assign visibility rules to his tags by assigning a distribution filter that defines to whom the tag can be made available. If the distribution filter is a social group distribution filter that permits the tags for sharing with identified friends or a predefined social community, and a requesting tagging device is not a member of that community, the processor 201 will limit distribution of the tag by not sending it to the requesting device. Requesting devices that are members of the community will receive the tag upon request.

In one or more embodiments the processor 201 can also be configured to limit the distribution of tags in accordance with an inbound tag receipt filter that is received from a tagging device configured as a receiving playback device. One can imagine that with a large number of users of the system (100), hundreds or thousands of tags can correspond to a popular movie or show. Accordingly, the user of a receiving playback device may not want the content cluttered with tags from every Tom, Dick, and Harry on earth. To prevent this, the user of the receiving playback device can assign an inbound tag receipt filter that is configured to define from whom tags can be received. If the inbound tag receipt filter identifies five tag creators from whom tags can be received, in response to a tag request the processor 201 can be configured to limit the distribution of tags by only delivering tags corresponding to the received content from those five tag creators.

Turning to FIG. 3, illustrated therein is a functional block diagram illustrating internal components and modules of one explanatory tagging device 101 configured in accordance with one or more embodiments of the invention. An explanatory tag 300, which has been created by a tag module 302, is also shown.

The tagging device 101 includes a processor 301, the tag module 302, an optional filter module 303, and an inbound tag module 304. The processor 301 can be any type of control device capable of executing the functions and operations of the tagging device 101, including a microprocessor, microcomputer, ASIC, and so forth. The processor 301 can be operable with an associated memory, which can store data such as operating systems, applications, and informational data. The operating system includes executable code that is used by the processor 301 to control basic functions of the tagging device 101, such as interaction among the various internal components, communication with external devices, and storage and retrieval of applications and data, to and from the memory. Applications stored in the memory can include executable code that utilizes an operating system to provide more specific functionality for the tagging device 101, such as the creation of tags, application of distribution or inbound tag receipt filters, and so forth. Informational data can be non-executable code or information that can be referenced and/or manipulated by an operating system or application for performing functions of the communication device.

The tag module 302 can be integrated into a wide variety of devices, including each of the tagging devices 101 (102,103,104,105,106) shown in FIG. 1, as well as other types of multimedia receiving and playback devices. The tag module 302 allows a user to create a tag 300 during the presentation of content. For instance, during the presentation of content, the tag module 302 can receive user input 305 from a user interface (not shown). As noted above, the user input 305 can take a variety of forms, including comments, ratings, recommendations, hyperlinks, content manipulation functions, or combinations thereof. Content manipulation functions, which can include start content functions, stop content functions, or combinations thereof, can be used in an aggregation of tags referred to as a “tag list” that defines a “highlight presentation” as will be described in more detail below with reference to FIG. 10.

Once the user input 305 is received, the tag module 302 can then associate the user input 305 with metadata 306 identifying the content being presented. Advantageously, the association of the metadata 306 with the user input 305 without attaching the user input 305 to the content. Accordingly, the tag 300 is referred to as a “content detached tag” because no content is attached thereto. In one embodiment, the metadata further identifies a temporal location in the content such that the tag can be presented at substantially the same location in the content during subsequent presentation of the content. In one embodiment, the temporal location is user definable, such that a user can move the content from the location where it was created to another location, such as the beginning or end of the content.

The tag module 302 can also be configured to assign a content level classification 308 to the tag 300. The content level classification 308 can be a scene level classification, a frame level classification, a program level classification, or other classification. Scene level classifications can mark or comment upon a scene of interest in content. Frame level classifications can mark or comment upon a frame of interest in content. Program level classifications can include reviews or ratings that comment or rate an entire work Similarly, program level classifications can include recommendations that recommend a particular piece of content to friends in a social group.

The filter module 303 can then be configured to assign a distribution filter 307 to the tag 300. Where included, the distribution filter 307 defines to whom the tag 300 can be made available. As noted above, distribution filters can be configured in a variety of ways. In one embodiment, the distribution filter 307 includes a direction for distribution of the tag 300 to a predefined social community, such as those determined by the social media server (111) operating in conjunction with the social information websites (112,113). Optionally, the predefined social community can be user defined and stored in the social media server (111) directly by the user. The predefined social community can be a selected group of friends, a subset of friends defined at another application or website, and so forth.

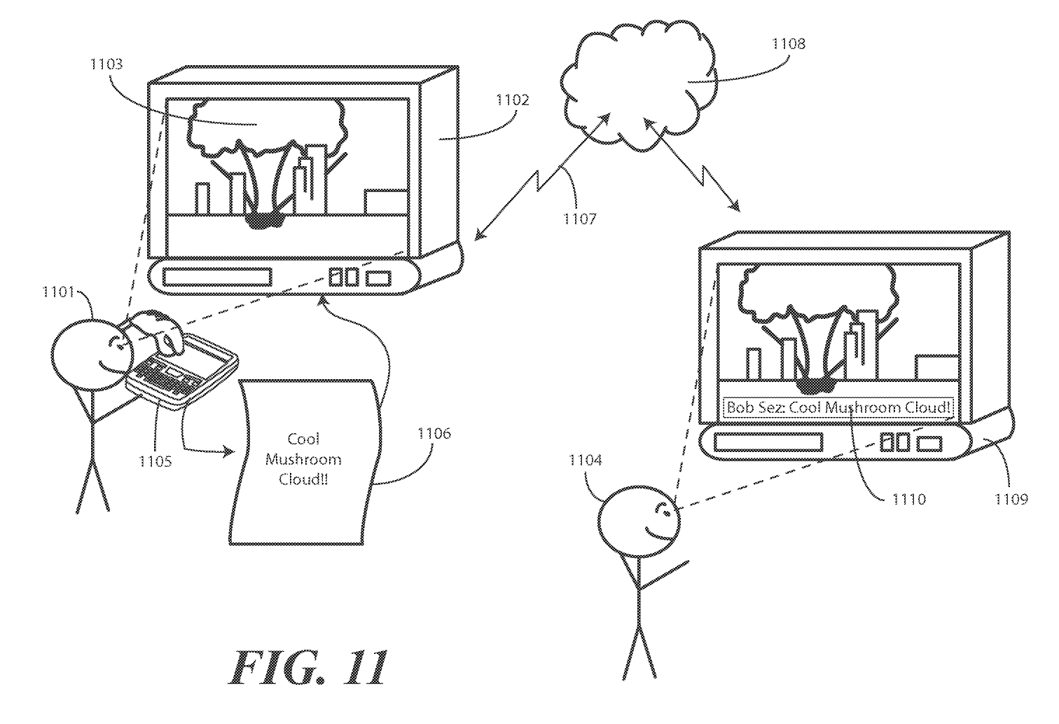

In one or more embodiments, a user identifier 309 can be attached to the tag 300. The user identifier 309 can identify the tags creator, so that when the tag 300 is distributed in accordance with the distribution filter 307, other users will know the tag's author. This will be shown in more detail in the use case depicted below with reference to FIG. 11.

When working together in a system (100) the tagging device 101 and server (107) function to allow a user to share tagged content with friends in a social network. If, for example, a user is watching the a program on television, regardless of the source of content, e.g., live broadcast feed, recorded program, etc., the user can create tags to comment on the whole program, a particular scene, a particular clip, or a particular frame. The tag creation process is interactive in that the user can interact with the tagging device 101 to provide that data. The tag 300, once created, can then be associated with metadata identifying the content and stored at the server (107).

Then, at a later point in time, another user comes home after the initial user has already created tags with comments about the content. If the other user falls within the distribution filter 307, when the other user is watching the same program at a later time, he can see the initial user's comments. Note that since the tags are content detached tags, the other user can see the initial user's comments regardless of the source of the content because the tags are associated with metadata of the content, not the content itself. The content stream being presented when the tags are created is not altered in any way. Instead, independent metadata associated with the content is referenced in the tag. The metadata can include scene level identifiers, program level identifiers, and so forth.

In one or more embodiments, the tag 300 is transmitted between the tagging device 101 and the server (107) via a hypertext transfer protocol. Similarly, requests for tags and response messages can be sent using the same protocol. Examples of some tag schemes are set below here as explanatory definitions. It should be understood that numerous other configurations and variations of tag definitions will be obvious to those of ordinary skill in the art having the benefit of this disclosure.

One illustrative configuration of a tag having a scene level classification may be as follows:

<element_name=“scene_tag”>

<element_name=“tag_id”:value=“integer”/>
<element_name=“device_id”:value=“integer”/>
<element_name=“user_id”:value=“integer”/>
<element_name=“asset_id”:value=“integer”/>
<element_name=“timestamp”:value=“long”/>
<element_name=“userdata”:value=“byte[ ]”/>

</element>

One illustrative configuration of a tag having a program level classification, with user content being a rating of a piece of content, may be as follows:

<element_name=“rating_tag”>

<element_name=“tag_id”:value=“integer”/>
<element_name=“device_id”:value=“integer”/>
<element_name=“user_id”:value=“integer”/>
<element_name=“asset_id”:value=“integer”/>
<element_name=“rating”:value=“int”/>
<element_name=“userdata”:value=“byte[ ]”/>

</element>

One illustrative configuration of a tag having a program level classification, with user content being a recommendation for a piece of content, may be as follows:

<element_name=“recommendation_tag”>

<element_name=“tag_id”:value=“integer”/>
<element_name=“device_id”:value=“integer”/>
<element_name=“user_id”:value=“integer”/>
<element_name=“asset_id”:value=“integer”/>
<element_name=“recommendation”:value=“string”/>
<element_name=“userdata”:value=“byte[ ]”/>

</element>

One illustrative configuration of a tag having a program level classification, with user content being a hyperlink to promote content awareness, may be as follows:

<element_name=“ca_tag”>

<element_name=“tag_id”:value=“integer”/>
<element_name=“device_id”:value=“integer”/>
<element_name=“user_id”:value=“integer”/>
<element_name=“asset_id”:value=“integer”/>
<element_name=“update_message”:value=“string”/>
<sequence>

<element_name=“embedded_link”:value=“hyperlink”/>

</sequence>
<element_name=“userdata”:value=“byte[ ]”/>

</element>

When requesting tags from the server (107) or when responding to the tagging devices 101, communication may be configured as follows:

<element_name=“cmt_interaction_msg”>

<element_name=“msg_type”:value=“integer”/>
<element_name=“device_id”:value=“integer”/>
<element_name=“user_id”:value=“integer”/>
<element_name=“reserved”:value=“byte[ ]”/>

</element>

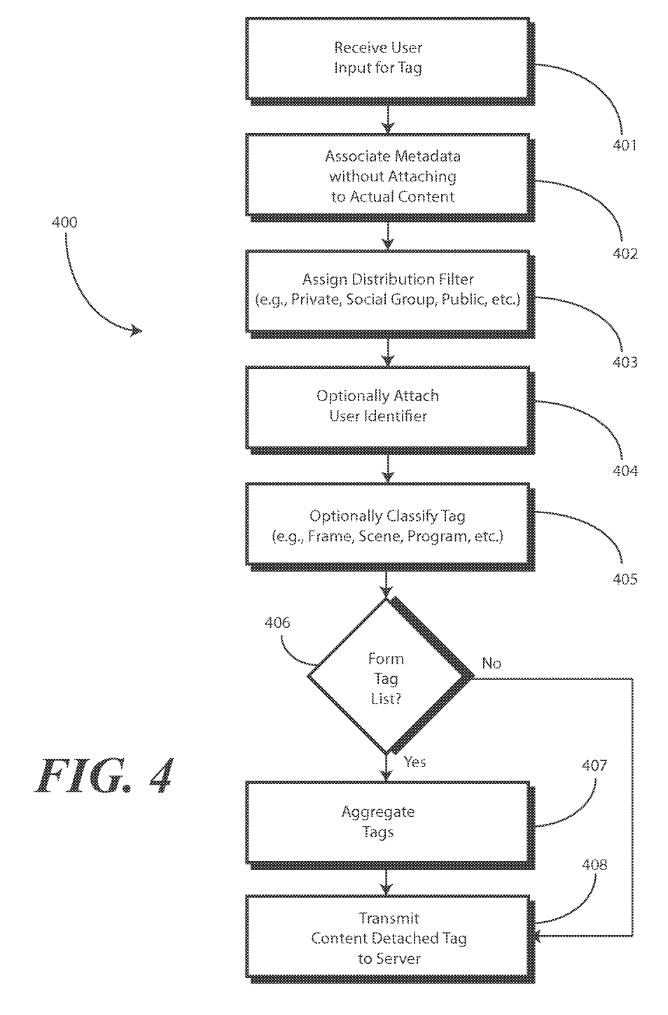

Turning now to FIG. 4, illustrated therein is a method 400 for creating tags in accordance with one or more embodiments of the invention. At step 401, a tagging device receives user input. In one embodiment, this occurs during the presentation of content. At step 402, the tagging device associates the user input with metadata identifying the content being presented. To form a content detached tag, the association step occurs without attaching the user input to the content. The metadata can also identify a temporal location in the content as well.

At step 403, the tagging device can assign a distribution filter to the tag. In one embodiment, the distribution filter defines to whom the content detached tag can be made available. At step 404, the tagging device can optionally attach a user identifier to the tag. The user identifier can correspond to the user input, such as when the user identifier identifies an author of the tag. At step 405, the tagging module can optionally assign a content level classification to the tag. The content level classification can be any of a scene level classification, a frame level classification, program level classification, or other type of classification.

In one or more embodiments, one of which will be described in more detail with reference FIG. 10 below, a plurality of tags can be aggregated together as a tag list at step 407. Tag lists can be used, for example, to create highlight presentations. The decision of whether this to be done occurs at decision 406. At step 408, the tagging device transmits the tag or tag list for distribution from the server in accordance with the distribution filter.

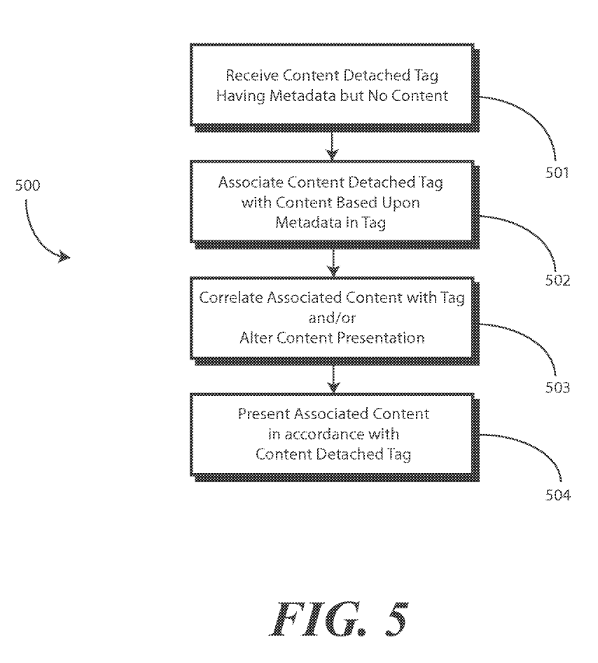

Turning to FIG. 5, illustrated therein is a method 500 for presenting tagged media in a tagging device. For example, when a tagging device is presenting tagged content to a user, the tagging device may request tags that are available in accordance with their distribution filters and that fall within the inbound tag receipt filter from the server. At step 501, the tagging device receives those tags.

At step 502, the tagging device associates the tag with the content to be presented. This occurs by associating the metadata of the tag with the metadata of the content to be presented. Once step 502 is complete, the tagging device determines whether the content needs to be presented differently at step 503, as would be the case when the received tag contains content manipulation functions. Alternatively, step 503 can include correlating the content with the tag. For instance, if the tag has a temporal location identifier associated therewith, the tagging module can use this information to make the user input of the tag present in accordance with the temporal location identifier. Said differently, step 503 can include identifying a temporal location of the original media content from the tag and presenting the tag at a location in the subsequent content that corresponds to the temporal location. At step 504, the tag is executed, acted upon, or presented during the presentation of the content. Where the user input comprises a content manipulation function, the presenting occurring at step 504 can be in accordance with the content manipulation function, e.g., starting or stopping content as requested by the user input.

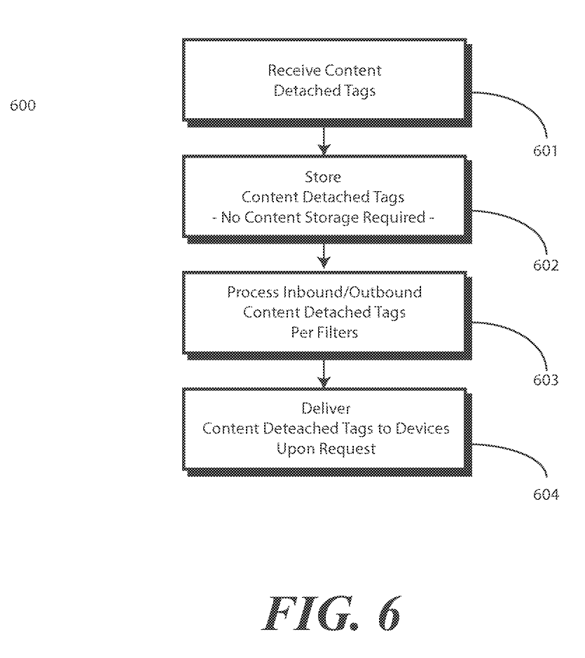

Turning to FIG. 6, illustrated therein is a method 600 of handling tags in a mediation device, one example of which is server (107) of FIG. 1. At step 601, the method 600 receives tags from one or more tagging devices. Each tag, as described above, has user input and metadata identifying content corresponding to the input, but does not have content attached. At step 602, the received tags are stored in a database or memory module. At step 604, the tags are processed such that they can be distributed to tagging devices in accordance with the distribution and inbound tag receipt filters described above. At step 605, the tags are delivered to other tagging devices. In one embodiment, this occurs in response to tag requests from those other tagging devices.

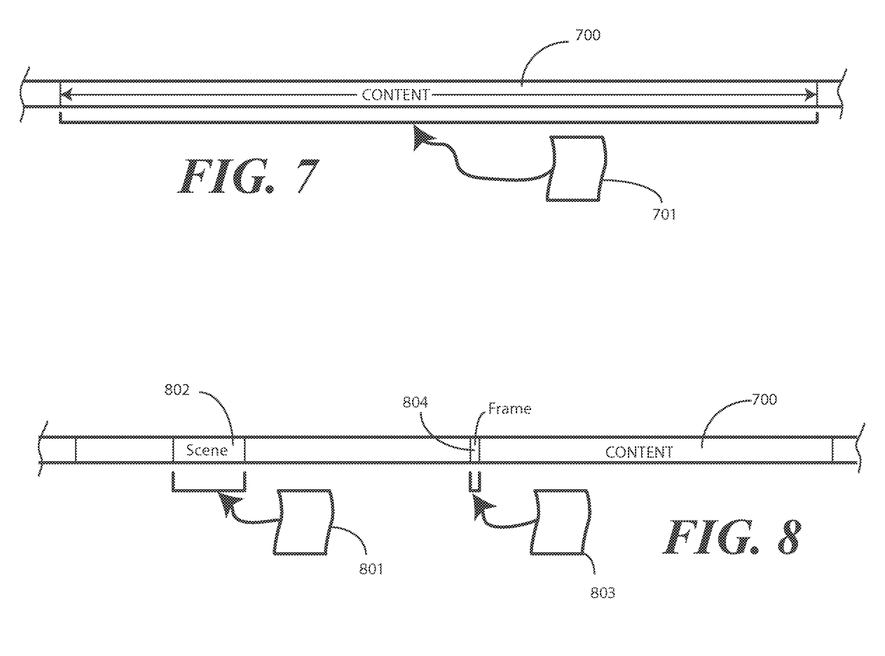

FIGS. 7-10 illustrate different tag classifications. FIG. 7 shows a program tag 701 that is associated with an entire piece of content. FIG. 8 shows a scene tag 801 that is associated with one particular scene 802 of the content 700. A frame tag 803 associated with a frame 804 of the content 700 is shown as well. Scene tags 801 and frame tags 803 would generally include temporal locations in the metadata that show which scene 802 or frame 804 they are associated with.

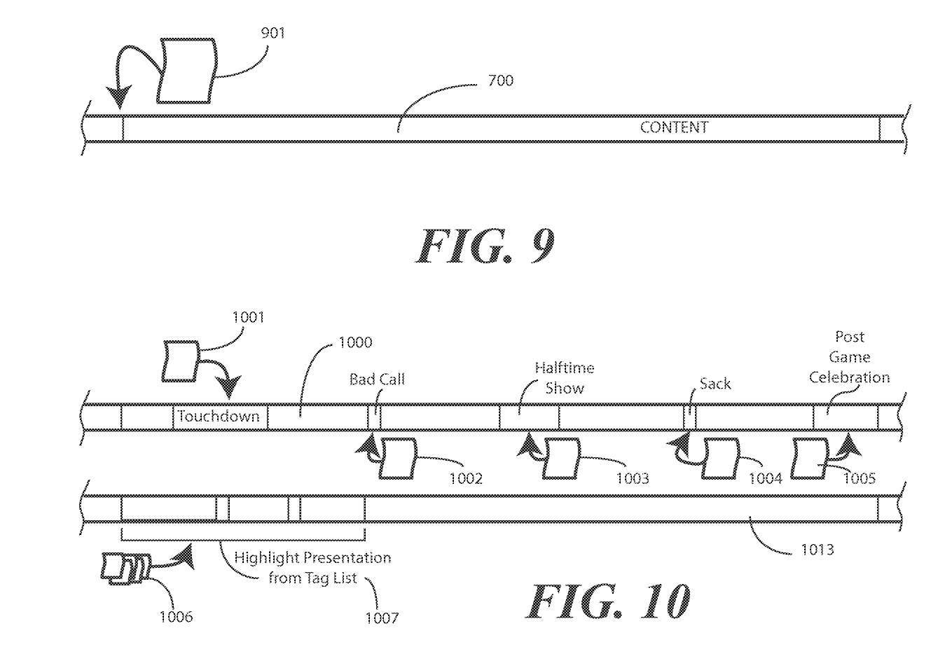

FIG. 9 shows a program tag 901 that has a user defined temporal location set to the beginning 902 of the content 700. This program tag 901 could be a rating or recommendation tag that a subsequent user can see prior to watching all of the content 700. Since this program tag 901 is a content detached tag, it can be sent to communication devices without content. For example, a subsequent user may wonder, “Should I watch last night's State of the Union address? I wonder what Bob thought about it.” The subsequent user may then request that the program tag 901 be sent to a web browser or via email or text to a mobile phone. The subsequent user can then read the program tag 901 to determine whether to invest the time to watch the State of the Union address. If Bob said, “It was captivating,” this may lead the subsequent user to watch the address from, for example, a DVR. If Bob said, “There was way too much clapping and no substance,” this may lead the subsequent user to invest his time in other ways.

Turning to FIG. 10, illustrated therein is a chart showing how pluralities of tags (1001,1002,1003,1004,1005) comprising content manipulation functions can be aggregated into a tag list 1006 to form a highlight presentation 1007. The concept of a highlight presentation 1007 is explained with the following example: Presume that the content 1000 is a football game. When a first viewer is watching the game, the viewer can create tags where the user input is a start content function, stop content function, or combinations thereof. Accordingly, the viewer can create a tag 1001 that starts and stops content on either side of a touchdown 1008. Similarly, tags 1002,10003,1004,1005 can be created to capture a bad call 1009, the halftime show 1010, a particularly good quarterback sack 1011 resulting in a game changing turnover, or the post-game celebration 1012. These tags 1001,1002,1003,1004,1005 function as bookmarks rather than content comments due to their unique user input. Once these tags 1001,1002,1003,1004,1005 have been created, they can be aggregated into a group called a tag list 1006. A subsequent viewer can have corresponding content 1013, such as if it was recorded to a DVR or is being ordered from a pay-per-view service. His tagging device can request and download the tag list 1006. The tagging device can then present the content 1013 in accordance with the tag list 1006 to present the highlight presentation 1007 so that the viewer only sees highlights of the game. Where the tag list 1006 is grouped with a hierarchy, the clips can be presented in the order the tags 1001,1002,1003,1004,1005 were created.

FIG. 11 illustrates a first explanatory use case illustrating how systems and methods described in the present application can be used. While a few uses cases will be described, it will be obvious to those of ordinary skill in the art having the benefit of this disclosure that any number of other applications can be created using the systems and methods described herein.

As shown in FIG. 11, a first user 1101 is watching television 1102. He sees a really fantastic explosion 1103 and wants to send a tagged message to a second user 1104. The first user 1101 happens to have a mobile telephone 1105 configured as a tagging device. The first user 1101 thus interacts with his mobile telephone to create a tag 1106. The user input of the tag 1106 says, “Cool mushroom cloud!” This tag 1106 then gets associated in the local device with metadata from the program. The metadata, in one embodiment, identifies the content and the location within the content where the user input was tagged. This tag 1106 is then transmitted 1107 across a network 1108 to a server (107).

Either simultaneously or at a later time, depending upon whether the second user 1104 is watching the program live or from another source, the second user 1104 decides to watch the same content. The second user 1104 can select whether to see tags from his social group. Where the second user 1104 so elects, the tag 1106 from his social group (which in this example includes the first user 1101) are downloaded to his local collaborative media tagging device 1109. When the particular scene identified by the tag 1106 occurs in the content, the first user's input 1110 appears.

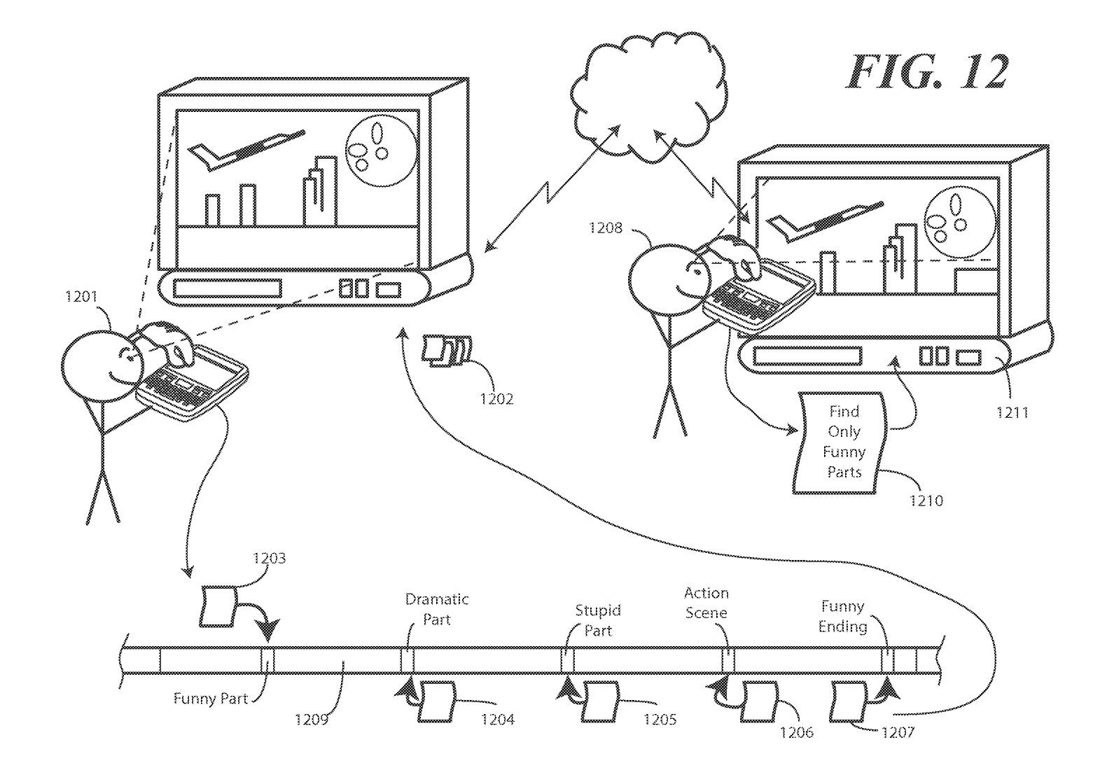

Turning to FIG. 12, a first user 1201 has created a tag list 1202 from several tags 1203,1204,1205,1206,1207. His user input has designated the tags 1203,1204,1205,1206,1207 based upon their dramatic style. Tags 1203,1207 have been designated “funny,” while tag 1204 has been designated “dramatic.” Tag 1205 has been designated as “just stupid,” while tag 1206 has been designated as an “action sequence.” The second user 1208, having had a long, hard day at work, is tired and does not wan to watch the entire content 1209. However, he is interested in getting a few laughs in before going to sleep. Using a search feature 1210 in his tagging device, he searches for only the funny parts, with each funny part being identified via the first user's tags. He thus watches scenes identified by the content manipulation actions of tag 1203 and tag 1207.

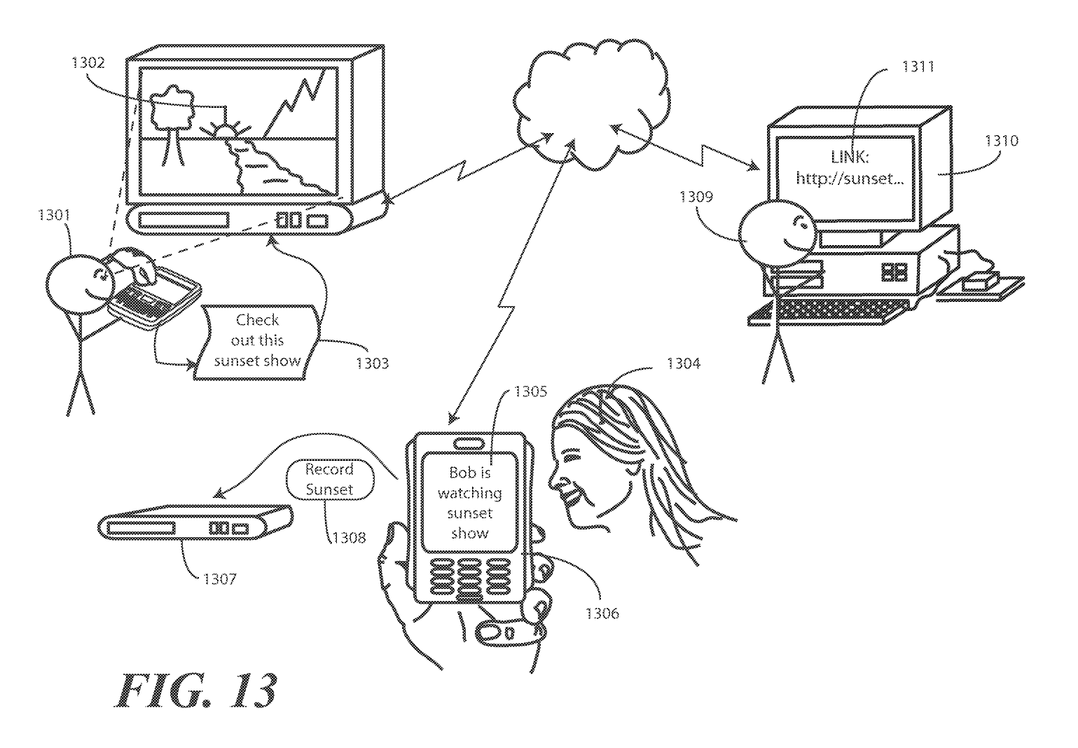

Turning to FIG. 13, a first user 1301 is watching a show 1302 on sunsets. He creates a tag 1303 that says, “check out this sunset show.” He also embeds a hyperlink to the show's website in the tag 1303.

A second user 1304 then gets a message 1305 sent via email to her mobile phone 1306.

The message 1305 states, “Bob is watching the sunset show.” Intrigued, the second user 1304 wants to watch the show 1302. Sadly, however, she has not scheduled it to record on her DVR 1307. However, in accordance with one embodiment, she is able to click on the hyperlink in the message 1305. This provides an option to send a record message 1308 to her DVR 1307.

In this example, at the same time, a third user 1309 happens to be surfing the web on his computer 1310. He sees a post on the first user's social media site that says, “Bob is watching the sunset show.” Intrigued, he accesses the hyperlink 1311 embedded in the post to access the content producer's website. He discovers that the content's director has created a series of professional tags using the system that provide insight and explanation to the camera settings used to obtain shots of the sunset. The director's distribution filter has been set to “public,” meaning that the third user 1309 will be able to see the director's tags if he gets the content. Being a photography enthusiast, the third user 1309 uses a provided hyperlink to purchase the show 1302 from a pay-per-download video distribution service.

As noted above, one of the numerous advantages of embodiments described herein is that the tags are “asset agnostic” in that they are not tied to content. They identify content, but are not tied to the media itself. Advantageously, this results in two different users being able to watch content from two different sources while being able to see other's tags corresponding to the content. For example, one person can watch a live broadcast while a second person watches a program that is recorded on a local recording device. The tags that are stored have an abstract identification of the content in the metadata. The local collaborative media tagging device then does “asset correlation” in that another user can watch the same content from a different source and see another user's comments as if he was watching the identical content seen by the first user. The ability to store tags independent of content reduces storage, latency, and also provides increased flexibility for the users.

One point of note: features like the distribution filters and classification of tags need not necessarily be set for each individual tag. In one or more embodiments, a policy setting can be established in a tagging device that allows a user to “shift lock” a certain distribution filter or classification. For example, if one member of a social community is designated to watch content and create a highlight presentation, he may set the policy such that all tags created will be scene level tags comprising content manipulation input, and are to be distributed only to his social community

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for tagging media, comprising:
during presentation of content, receiving user input in a media tagging device;
associating, in the media tagging device, the user input with metadata identifying the content being presented without attaching the user input to the content to form a content detached tag;
assigning a distribution filter to the content detached tag, the distribution filter defining to whom the content detached tag can be made available; and
transmitting the content detached tag from the media tagging device for distribution from a server in accordance with the distribution filter.

2. The method of claim 1, further comprising attaching a user identifier corresponding to the user input to the content detached tag.

3. The method of claim 1, wherein the metadata further identifies a temporal location in the content associated with the content detached tag.

4. The method of claim 1, further comprising assigning a content level classification to the content detached tag.

5. The method of claim 4, wherein the content level classification is one of a scene level, a frame level, or a program level.

6. The method of claim 5, wherein the user input comprises one of a comment, a rating for the content, a content recommendation, or combinations thereof.

7. The method of claim 1, wherein the distribution filter comprises a direction for distribution to a predefined social community

8. The method of claim 1, wherein the user input comprises a content manipulation function.

9. The method of claim 8, wherein the content manipulation function comprises one of a start content function, a stop content function, or combinations thereof.

10. The method of claim 9, further comprising aggregating a plurality of content detached tags into a tag list.

11. The method of claim 10, wherein the tag list defines a content highlight presentation.

12. A method for presenting tagged media, comprising:
receiving, at a media presentation device, a content detached tag comprising user input and metadata identifying media content corresponding to the user input without having the media content attached thereto; and
associating the content detached tag to content corresponding to the metadata; and
presenting the content detached tag during presentation of the content associated with the content detached tag.

13. The method of claim 12, wherein the presenting occurs in accordance with an inbound tag receipt filter defining from whom tags may be presented.

14. The method of claim 13, wherein the inbound tag receipt filter defines a predetermined social community

15. The method of claim 12, wherein the user input comprises a content manipulation function, wherein the presenting occurs in accordance with the content manipulation function.

16. The method of claim 12, further comprising identifying a temporal location of the media content from the content detached tag, wherein the presenting comprises presenting the content detached tag at a location in the content corresponding to the temporal location.

17. A collaborative media tagging system, comprising:
an interface for communication with one or more media tagging devices;
a tag receiving module configured for receiving content detached tags from the one or more media tagging devices, wherein each content detached tag comprises user input and metadata identifying media content corresponding to the user input without having the media content attached thereto;
a memory module for storing one or more received content detached tags;
a tag delivery module; and
a processor configured to, upon receiving tag requests identifying content, deliver, through the tag delivery module, one or more content detached tags having the metadata corresponding to the content.

18. The collaborative media tagging system of claim 17, wherein the processor is configured to limit distribution of the one or more content detached tags in accordance with a distribution filter.

19. The collaborative media tagging system of claim 17, wherein the processor is configured to limit distribution of the one or more content detached tags in accordance with an inbound tag receipt filter received from a receiving play back device.

20. The collaborative media tagging system of claim 17, further comprising a recommendation module configured to mine the one or more received content detached tags in response to the receiving tag requests and deliver, through the tag delivery module, aggregate user data drawn from one or more mined content detached tags.
